(19) United States
(12) Patent Application Publication
(10) Pub. No.: US 2018/0281066 A1
(43) Pub. Date: Oct. 4, 2018

(54) THREE-DIMENSIONAL PRINTER

(71) Applicant: Safran Aero Boosters S.A., Herstal (BE)

(72) Inventors: Laurent Schuster, Erezée (BE); Eric Englebert, Amay (BE)

(73) Assignee: Safran Aero Boosters S.A., Herstal (BE)

(21) Appl. No.: 15/938,237

(22) Filed: Mar. 28, 2018

(30) Foreign Application Priority Data
Mar. 30, 2017 (BE) 2017/5217

(51) Int. Cl. B22F 3/105; B33Y 10/00; B33Y 30/00

(52) U.S. Cl. CPC B22F 3/1055; B22F 2003/1056; B33Y 30/00; B33Y 10/00

(57) ABSTRACT

The present invention relates to a three-dimensional printer in which a localized powder flow is deposited on a construction surface. The three-dimensional printer comprises an electrostatic charge detector for measuring a characteristic of an electrostatic charge of the powder flow, for example the electrostatic charge thereof or the electrostatic charge thereof per unit of time. Said detector makes it possible to prevent explosions caused by the accumulation of electrostatic charge.

### TECHNICAL FIELD

According to a first aspect, the invention relates to a three-dimensional printer for manufacturing a component by additive layers. According to a second aspect, the invention relates to a three-dimensional printing method.

### PRIOR ART

WO2016044876A1 describes a three-dimensional printing system in which a localized powder flow is deposited on a construction surface. Here, an energy beam heats the powder and melts it in order to form an object.

Inventors have observed explosions and smoke emission when using a three-dimensional printing system which a localized powder flow is deposited on a construction surface.

These explosions and smoke emissions are a source of danger. Moreover, they force the three-dimensional printing process to be halted, which wastes production time, and the component being printed is lost.

### SUMMARY OF THE INVENTION

One of the aims of the invention is to provide a three-dimensional printing system in which a localized powder flow is deposited on a construction surface and which has a lower risk of explosion and smoke emission.

According to a first aspect, the invention relates to a three-dimensional printer for manufacturing a component by additive layers, which printer comprises:

a construction surface,

a feed means arranged to supply a powder flow to the construction surface and comprising a first feed pipe leading to the construction surface,

a means for transmitting an energy beam to the construction surface,

a movement means for generating a relative movement of the construction surface and the feed means,

characterized in that said printer further comprises an electrostatic charge detector arranged to measure a characteristic of an electrostatic charge of said powder flow.

Inventors have been able to attribute the explosions and smoke emission to the electrostatic charge of the powder particles. The electrostatic charge detector arranged to measure a characteristic of an electrostatic charge of said powder flow makes it possible to determine the electrostatic charge of the powder, or a related characteristic, and thus to be able to take measures to prevent explosions and smoke emission. Such measures may include stopping printing and/or emitting a warning signal, for example.

The characteristic of the electrostatic charge may be the electrostatic charge, the electrostatic charge per unit of time or the electrostatic charge density of the powder flow, for example.

It should be noted that WO2016044876A1 considers the electrostatic charge of powder particles to be an advantage. According to this document, by charging the construction surface with a charge opposite to that of the powder particles, it is possible to prevent the powder particles from rolling on the construction surface.

The invention relates to a three-dimensional printer, i.e. a printer for printing in three dimensions, for manufacturing components by additive layers (known as additive layer manufacturing).

In one embodiment of the invention, the powder leaves the feed means a little above the construction surface during the relative movement of the construction surface and the feed means. The powder is heated by the energy beam just before said beam touches the construction surface or after said beam has touched said surface. The temperature of said powder increases and said powder agglutinates with the powder material previously deposited and heated, so as to form an object.

At the beginning of the process of manufacturing the object, the first feed pipe supplies the powder directly onto the construction surface. Preferably, when the first layer of the object has been produced, the construction surface is moved downwards relative to the first feed pipe, or said feed pipe is moved upwards relative to the construction surface. The first feed pipe thus transports the powder to the construction surface on the layer of the object that has just been printed, so as to continue manufacturing the object.

The movement means can move at least one of: the construction surface, the feed means, a portion of the feed means, the first feed pipe and a second feed pipe.

In one embodiment of the invention, the feed means is a means for transporting the powder from a container.

The feed means preferably supplies the powder flow in a localized manner above the construction surface. Moreover, the energy beam is preferably capable of fusing the powder together as said powder is being supplied by the feed means.

The electrostatic charge detector preferably allows the entire powder flow to pass through. There is no filter which would block some of the powder flow, for example.

In one embodiment of the invention, the construction surface is formed by the top of a plate of the three-dimensional printer.

The electrostatic charge detector advantageously comprises a duct that is arranged such that at least some, preferably all of the powder flow passes therethrough. This means that measuring the charge does not halt the process of manufacturing the object, since it does not result in a delay in the powder flow circulation.

In one embodiment of the invention, the duct comprises a cage, for example a Faraday cage, which is connected to an electrometer.

Advantageously, the three-dimensional printer further comprises an output unit arranged to provide information about the measured characteristic of the electrostatic charge of the powder flow.

The output unit may be an indicator light that lights up, a sound emitter that is set off if the electrostatic charge or the electrostatic charge per unit of time exceeds a predetermined threshold, or a display device that displays a piece of data determined from the information about the measured characteristic of the electrostatic charge of the powder flow, for example.

The output unit advantageously comprises an output to a computing device. By means of the output unit, information about the measured characteristic of the electrostatic charge of the powder flow is transmitted to said computing device. Said computing device can thus monitor the measured characteristic of the electrostatic charge of the powder flow.

The three-dimensional printer advantageously comprises a control unit that is electrically connected to the electrostatic charge detector and is arranged to halt a printing process being carried out by the three-dimensional printer when the measured characteristic of the electrostatic charge meets a predetermined condition. This makes it possible to stop the printing process if there is a risk of explosion. The predetermined condition may be, for example, that the total charge since the start of the process of manufacturing the object exceeds a threshold or that the instantaneous charge density exceeds a threshold.

The three-dimensional printer advantageously comprises a counter arranged to determine the total charge of the powder flow measured since the counter was reset. This makes it possible to prevent the electrostatic charge accumulated in the printing chamber from exceeding a specific threshold.

Advantageously, the electrostatic charge detector is arranged to measure an electric charge of the powder flow per unit of time.

Advantageously, the powder comprises a metal. The powder may be entirely metal, or may comprise a metal and a non-metal.

Advantageously, the energy beam is an electron beam or a laser beam. For example, the three-dimensional printer may be of the electron beam manufacturing type.

The electrostatic charge detector is advantageously positioned between the first feed pipe and the construction surface, preferably at one end of the first feed pipe. This removes the need to drastically modify an existing printer in order to implement the invention.

Advantageously, the three-dimensional printer comprises a powder container and the electrostatic charge detector is positioned between a portion, or an end, of the first feed pipe leading to the construction surface and said container. In addition to or instead of the first electrostatic charge detector between the first feed pipe and the construction surface, there may be an electrostatic charge detector positioned further upstream with respect to the powder circulation.

Advantageously, the feed means comprises a second feed pipe leading to the construction surface, the first feed pipe being provided for transporting a first portion of the powder flow to the construction surface and the second feed pipe being provided for transporting a second portion of the powder flow to the construction surface. The first and the second portions of the powder flow preferably form the entire powder flow.

The feed means may comprise three, four or more feed pipes leading to the construction surface, each transporting a portion of the powder flow. The feed pipes are preferably arranged such that the powder beams emerging therefrom converge.

The electrostatic charge detector therefore preferably comprises a plurality of portions, each portion being arranged to measure a characteristic of an electrostatic charge of a portion of the powder flow. In one embodiment of the invention, it is thus possible to determine the characteristic of the electrostatic charge for the entire powder flow.

The electrostatic charge detector preferably comprises a first portion arranged to measure a characteristic of an electrostatic charge of the first portion of the powder flow and a second portion arranged to measure a characteristic of an electrostatic charge of the second portion of the powder flow.

The first feed pipe and the second feed pipe preferably meet at a junction that is connected to a container by a third feed pipe, the electrostatic charge detector being arranged to measure the powder flow in said third feed pipe. This makes it possible to have a central measurement in addition to or instead of measurements in each of the portions of the powder flow.

According to a second aspect, the invention proposes a method for three-dimensionally printing by additive layers, comprising the steps of:

(a) supplying a powder flow to a construction surface via a feed means comprising a first feed pipe leading to the construction surface,

(b) moving the construction surface and/or the feed means in order to generate a relative movement of the construction surface and the feed means,

(c) transmitting an energy beam to the construction surface,

characterized in that said method comprises measuring a characteristic of an electrostatic charge of said powder flow.

The method preferably comprises taking measures to prevent explosions and smoke emission. The steps are preferably simultaneous.

The advantages mentioned for the device apply, mutatis mutandis, to the method.

### DESCRIPTION OF THE DRAWINGS

Other features and advantages of the invention will become apparent upon reading the following detailed description, for the understanding of which reference will be made to the accompanying drawings, in which:

FIG. 1 shows a three-dimensional printer according a first embodiment of the invention;

FIG. 2 shows a three-dimensional printer according to a second embodiment of the invention; and

FIG. 3 shows a three-dimensional printer according to a third embodiment of the invention.

### DETAILED DESCRIPTION

The present invention is described with particular embodiments and references to figures but the invention is not limited by these. The drawings or figures described are merely schematic and are not limitative.

In the context of the present document, the terms “first” and “second” serve solely to differentiate the various elements and do not imply any order between these elements.

In the figures, identical or similar elements may have the same reference numerals.

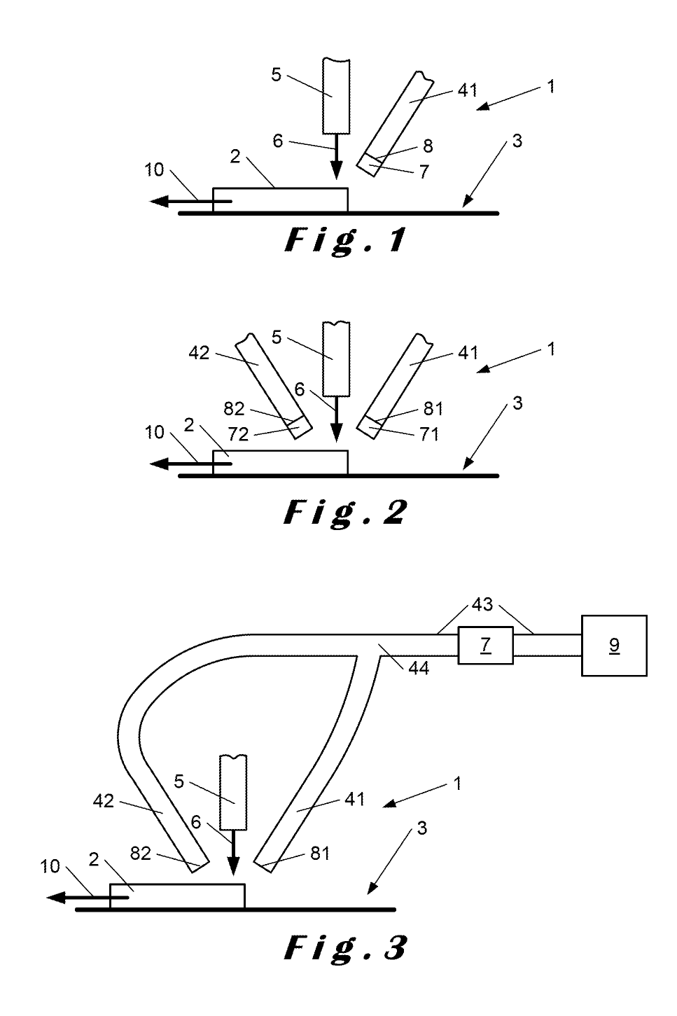

FIG. 1 shows a three-dimensional printer 1 according to a first embodiment of the invention. FIG. 2 shows a three-dimensional printer 1 according to a second embodiment of the invention. FIG. 3 shows a three-dimensional printer 1 according to a third embodiment of the invention.

The three-dimensional printer 1 comprises a construction surface 3, a feed means arranged to supply a powder flow to the construction surface 3, a means 5 for transmitting an energy beam 6 to the construction surface 3 and an electrostatic charge detector 7, 71, 72 arranged to measure a characteristic of an electrostatic charge of the powder flow. The three-dimensional printer 1 preferably comprises a printing chamber (not shown).

The three-dimensional printer 1 further comprises a movement means for generating a relative movement 10 of the construction surface 3 and the feed means.

In the first embodiment of the invention, which is shown in FIG. 1, the feed means comprises a first feed pipe 41 leading to the construction surface 3. The electrostatic charge detector 7 is secured to one end 8 of said first feed pipe 41 such that the powder flow leaving said end passes through said detector.

In the second embodiment of the invention, which is shown in FIG. 2, the feed means comprises a first feed pipe 41 and a second feed pipe 42, the two pipes both leading to the construction surface 3. The electrostatic charge detector comprises a first portion 71 that is secured to one end 81 of the first feed pipe 41 such that the portion of the powder flow leaving said end 81 passes through said detector, and a second portion 72 that is secured to one end 82 of the second feed pipe 42 such that the portion of the powder flow leaving said end 82 passes through said detector.

In the third embodiment of the invention, which is shown in FIG. 3, the feed means comprises a first feed pipe 41 and a second feed pipe 42, the two pipes both leading to the construction surface 3. The first feed pipe 41 and the second feed pipe 42 meet at a junction 44. The feed means further comprises a third feed pipe 43 which fluidically connects the junction 44 to a container 9. The electrostatic charge detector 7 is preferably secured to the third feed pipe 43 such that the entire powder flow passes through said detector at a single location.

The features of the different embodiments of the invention can be combined. For example, an electrostatic charge detector 7 may be positioned anywhere on the first feed pipe 41 when there is only one feed pipe. It is also possible for the printer to have a plurality of electrostatic charge detectors 7 positioned at various locations.

In other words, the invention relates to a three-dimensional printer 1 in which a localized powder flow is deposited on a construction surface 3. The three-dimensional printer 1 comprises an electrostatic charge detector 7, 71, 72 for measuring a characteristic of an electrostatic charge of the powder flow, for example the electrostatic charge thereof or the electrostatic charge thereof per unit of time. Said detector 7, 71, 72 makes it possible to prevent explosions caused by the accumulation of electrostatic charge.

The present invention has been described in relation to specific embodiments, which have a purely illustrative value and must not be considered to be limitative. In general terms, the present invention is not limited to the examples illustrated and/or described above. The use of the verbs “comprise”, “include”, “have”, or any other variant, as well as conjugations thereof, may in no way exclude the presence of elements other than those mentioned. The use of the indefinite article “a” or “an” or of the definite article “the”, to introduce an element, does not exclude the presence of a plurality of these elements. The reference numerals in the claims do not limit the scope thereof.

The embodiments of the invention in which an exclusive property or privilege is claimed are defined as follows:

1. Three-dimensional printer for manufacturing a component by additive layers, which printer comprises:
a construction surface,
a feed means arranged to supply a powder flow to the construction surface and comprising a first feed pipe leading to the construction surface,
a means for transmitting an energy beam to the construction surface,
a movement means for generating a relative movement of the construction surface and the feed means,
characterized in that said printer further comprises an electrostatic charge detector arranged to measure a characteristic of an electrostatic charge of said powder flow.

2. Three-dimensional printer according to claim 1, wherein the electrostatic charge detector comprises a duct that is arranged such that at least some, preferably all of the powder flow passes therethrough.

3. Three-dimensional printer according to claim 1, further comprising an output unit arranged to provide information about the measured characteristic of the electrostatic charge of the powder flow.

4. Three-dimensional printer according to claim 3, wherein the output unit comprises an output to a computing device.

5. Three-dimensional printer according to claim 1, further comprising a control unit that is electrically connected to the electrostatic charge detector and is arranged to halt a printing process being carried out by the three-dimensional printer when the measured characteristic of the electrostatic charge meets a predetermined condition.

6. Three-dimensional printer according to claim 1, further comprising a counter arranged to determine the total charge of the powder flow measured since the counter was reset.

7. Three-dimensional printer according to according to claim 1, wherein the electrostatic charge detector is arranged to measure an electric charge per unit of time of the powder flow.

8. Three-dimensional printer according to according to claim 1, wherein the powder comprises a metal.

9. Three-dimensional printer according to according to claim 1, wherein the energy beam is an electron beam or a laser beam.

10. Three-dimensional printer according to according to claim 1, wherein the electrostatic charge detector is positioned between the first feed pipe and the construction surface, preferably at one end of the first feed pipe.

11. Three-dimensional printer according to claim 1, further comprising a powder container, wherein the electrostatic charge detector is positioned between a portion of the first feed pipe leading to the construction surface and the powder container.

12. Three-dimensional printer according to claim 1, wherein the feed means comprises a second feed pipe leading to the construction surface, the first feed pipe being provided for transporting a first portion of the powder flow to the construction surface and the second feed pipe being provided for transporting a second portion of the powder flow to the construction surface.

13. Three-dimensional printer according to claim 12, wherein the electrostatic charge detector preferably comprises a first portion arranged to measure a characteristic of an electrostatic charge of the first portion of the powder flow and a second portion arranged to measure a characteristic of an electrostatic charge of the second portion of the powder flow.

14. Three-dimensional printer according to claim 12, wherein the first feed pipe and the second feed pipe meet at a junction that is connected to a container by a third feed pipe, the electrostatic charge detector being arranged to measure the powder flow in said third feed pipe.

15. Method for three-dimensionally printing by additive layers, comprising the steps of:
supplying a powder flow to a construction surface via a feed means comprising a first feed pipe leading to the construction surface;
moving the construction surface and/or the feed means in order to generate a relative movement of the construction surface and the feed means;
transmitting an energy beam to the construction surface; and
characterized in that said method comprises measuring a characteristic of an electrostatic charge of said powder flow and taking measures to prevent explosions and smoke emission.
